(19) United States
(12) Patent Application Publication
(10) Pub. No.: US 2004/0031572 A1
(43) Pub. Date: Feb. 19, 2004

(54) Venetian blind

(76) Inventors: Tai-Long Huang, Fuhsing (TW); Jang-Chang Wang, Taipei (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/267,879

(22) Filed: Oct. 10, 2002

(30) Foreign Application Priority Data
Aug. 15, 2002 (TW) 91212689

(51) Int. Cl. E06B 3/32

(52) U.S. Cl. 160/89

(57) ABSTRACT

A venetian blind includes a clamp element having a recess portion, an insert element insertable fittingly into the recess portion of the clamp element, a shade cloth having a portion inserted and pressed into the recess portion of the clamp element by the insert element, and a slat having an end portion connected to one of the clamp element and the insert element.

### BACKGROUND OF THE INVENTION

1. Field of the Invention

The invention relates to a venetian blind, more particularly to a venetian blind that is easy to assemble and disassemble.

2. Description of the Related Art

Referring to FIG. 1, a conventional vertically extending venetian blind is shown to include a headrail 1, a plurality of carrier slides 2 slidable along a longitudinal direction of the headrail 1, a plurality of slats 3 each of which is hung on a respective one of the carrier slides 2, and a shade cloth 4 hung on the carrier slides 2 at holes 401. The slats 2 are covered by parts of the shade cloth 4.

Referring to FIG. 2, a conventional horizontally extending venetian blind is shown to include a headrail 5, a shade cloth 7, and a plurality of slats 6 covered by parts of the shade cloth 7. The venetian blind further includes a tilt rod 501 mounted in the headrail 5, and two lift cords 502 connected to the tilt rod 501 and penetrating through the slats 6. The shade cloth 7 includes a plurality of covering portions 701 covering the slats 6, and a plurality of connecting portions 702 each interconnecting an adjacent pair of the covering portions 701. Each of the covering portions 701 of the shade cloth 7 is formed with two holes 703 to permit penetrating of the lift cords 502 therethrough.

The aforesaid conventional venetian blinds suffer from shortcomings, such as complicated assembly, requisite precision processing, and a relatively large amount of shade cloth.

### SUMMARY OF THE INVENTION

The main object of the present invention is to provide a venetian blind that is easy to assemble and disassemble.

The venetian blind according to this invention includes a clamp element having a recess portion, an insert element insertable fittingly into the recess portion of the clamp element, a shade cloth having a portion inserted and pressed into the recess portion of the clamp element by the insert element, and a slat having an end portion connected to one of the clamp element and the insert element.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary perspective view of a conventional venetian blind;

FIG. 2 is a perspective view of another conventional venetian blind;

FIGS. 3 to 5 are sectional views of the first preferred embodiment of the venetian blind according to this invention;

FIG. 6 is a sectional view of the second preferred embodiment of the venetian blind according to this invention; and

FIG. 7 is a sectional view of the third preferred embodiment of the venetian blind according to this invention.

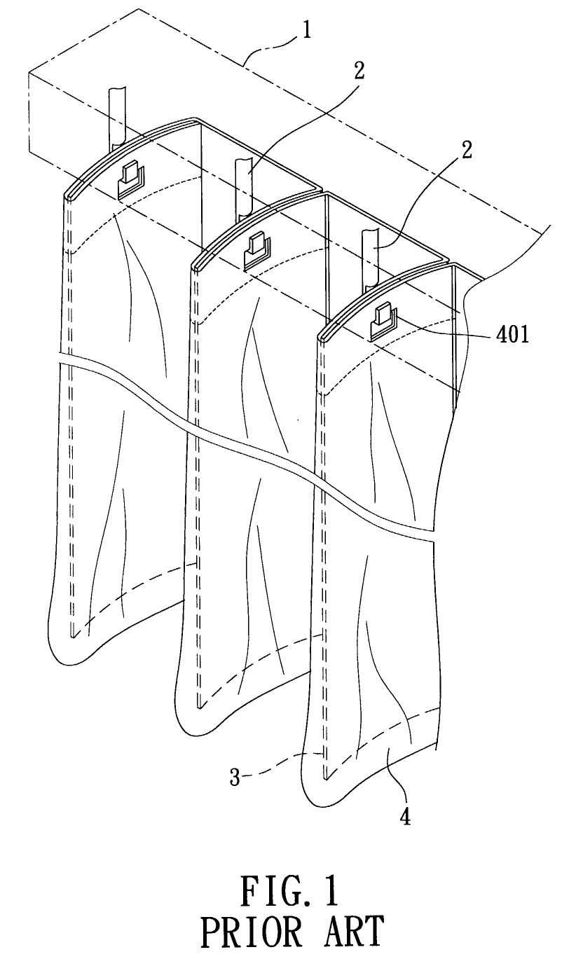

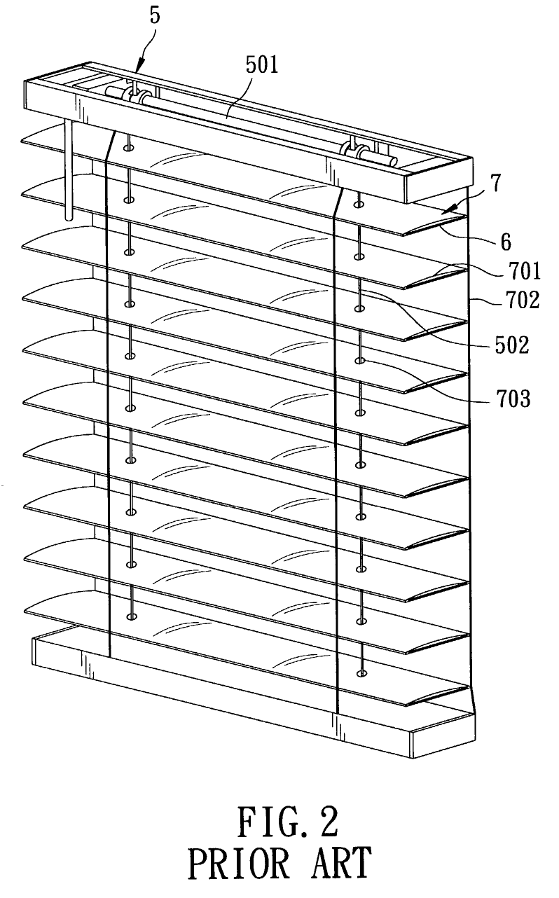

### DETAILED DESCRIPTION OF THE PREFERRED EMBODIMENTS

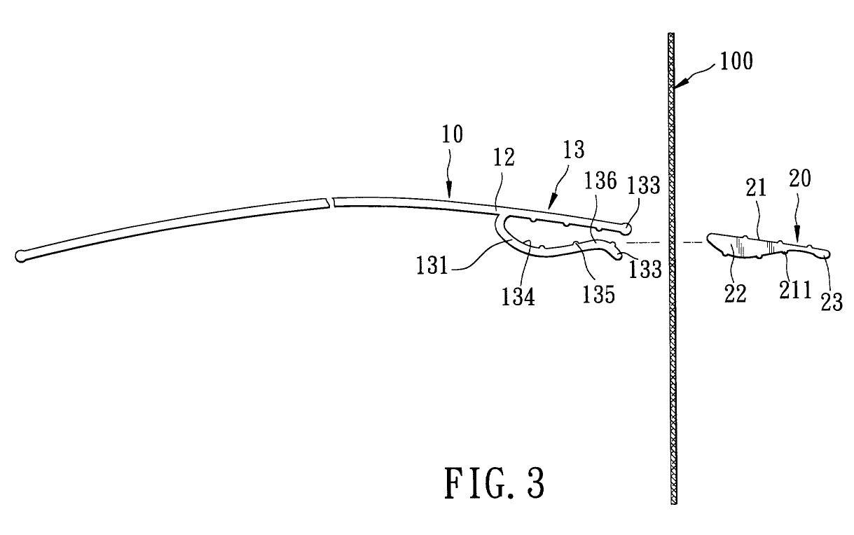

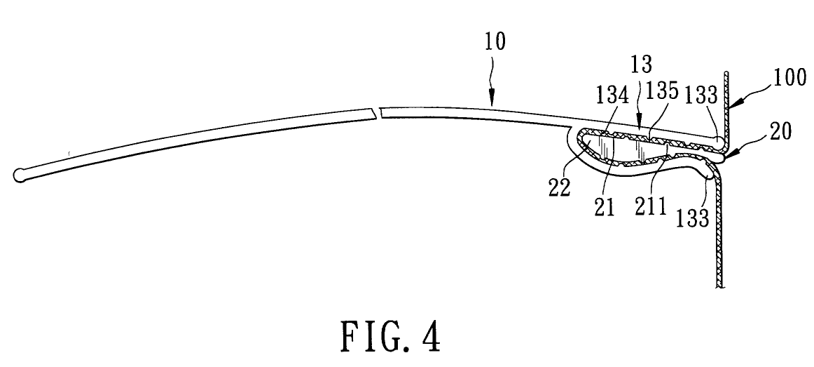

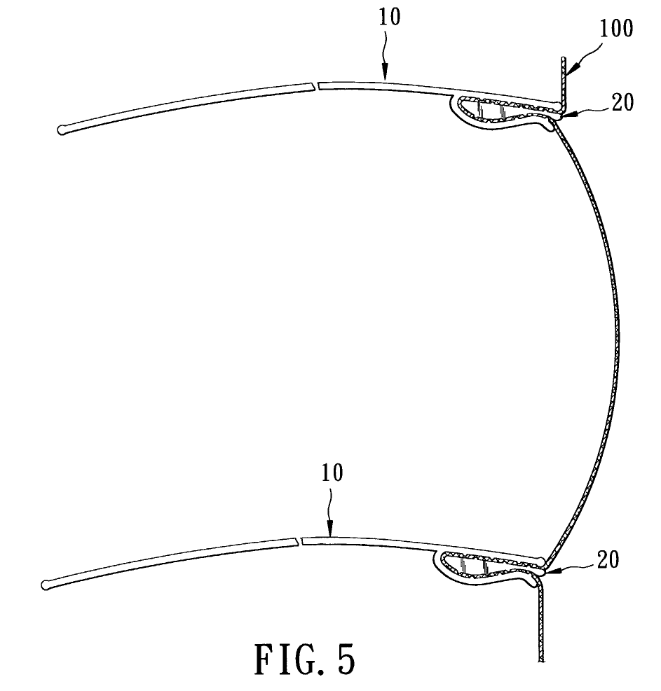

Referring to FIGS. 3 to 5, the first preferred embodiment of the venetian blind according to this invention is shown to include a clamp element 13 having a recess portion 131, an insert element 20 insertable fittingly into the recess portion 131 of the clamp element 13, a shade cloth 100 having a portion inserted and pressed into the recess portion 131 of the clamp element 13 by the insert element 20, and a slat 10 having an end portion 12 connected to the clamp element 13.

The clamp element 13 is formed integrally with the slat 10, and is made of a resilient material. The clamp element 13 further includes an outer entrance open end 133 opposite to the recess portion 131, and a necked down portion 136 connected between the recess portion 131 and the outer entrance open end 133. The outer entrance open end 133 diverges outwardly from the necked down portion 136. The clamp element 13 is provided with a plurality of spaced surface protrusions 135 on the inner surface 134 thereof.

The insert element 20 has a head part 22 to be received in the recess portion 131 of the clamp element 13, and an operating part 23 opposite to the head part 22. The cross section of the operating part 23 of the insert element 20 is smaller than that of the head part 22 of the insert element 20. The cross section of the head part 22 is greater than that of the necked down portion 136. The insert element 20 is also provided with a plurality of spaced surface protrusions 211 on the surface 21 of the insert element 20. The surface protrusions 135 on the clamp element 13 are staggered relative to the surface protrusions 211 of the insert element 20 so as to fix the portion of the shade cloth 100 interposed between the clamp element 13 and the insert element 20.

When assembling the venetian blind of this embodiment, the shade cloth 100 can be easily installed by inserting and pressing a plurality of proper portions of the shade cloth 100 into the recess portions 131 of the clamp elements 13 using the insert elements 20. Accordingly, when the shade cloth 100 is to be disassembled for washing, the portions of the shade cloth 100 proximate to the outer entrance open ends 133 of the clamp elements 13 can be stretched so as to remove the shade cloth 100 from the recess portions 131 of the clamp elements 13.

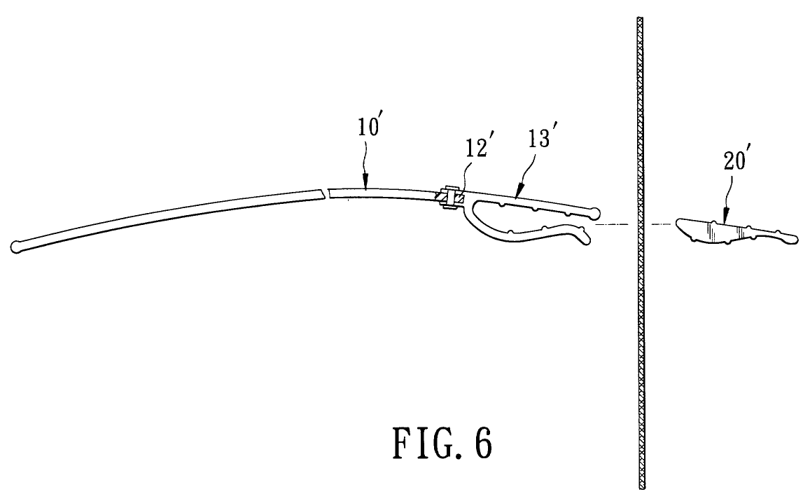

Referring to FIG. 6, a second preferred embodiment of the venetian blind according to this invention is shown to be similar to the first preferred embodiment except the clamp element 13′ is formed separately, and is then joined to the end portion 12′ of the slat 10′ by any proper manner, such as by riveting.

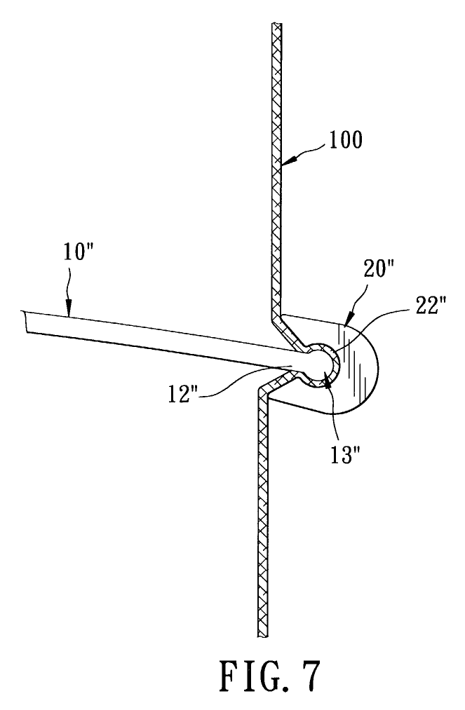

Referring to FIG. 7, a third preferred embodiment of the venetian blind according to this invention is shown. In this embodiment, the insert element 13″ is connected to the end portion 12″ of the slat 10″, and is formed integrally with the slat 10″. Furthermore, the insert element 13″ is formed in a substantially ball-shape. The clamp element 20″ is formed with a recess portion 22″ corresponding to the ball-shaped insert element 13″.

It should be noted that the length of the elements 20, 20′, 20″ may be substantially equal to the longitudinal length of the slats 10, 10′, 10″ (i.e., the elements 20, 20′, 20″ have a one-to-one relationship with the slats 10, 10′, 10″). In other embodiments, the elements 20, 20′, 20″ may be shorter than the slats 10, 10′, 10″ and have a many-to-one relationship therewith. Moreover, it is also possible that the slats 10, 10′, 10″ have opposite end portions connected to the clamp element 13, 13′ or the insert element 13″ such that the venetian blind can include two shade cloths 100 retained at the opposite end portions of the slats 10, 10′, 10″.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A venetian blind comprising:
a clamp element having a recess portion;
an insert element insertable fittingly into said recess portion of said clamp element;
a shade cloth having a portion inserted and pressed into said recess portion of said clamp element by said insert element; and
a slat having an end portion connected to one of said clamp element and said insert element.

2. The venetian blind as claimed in claim 1, wherein said clamp element further includes an outer entrance open end opposite to said recess portion, and a necked down portion connected between said recess portion and said outer entrance open end.

3. The venetian blind as claimed in claim 2, wherein said insert element has a head part to be received in said recess portion of said clamp element, said head part having a cross section greater than that of said necked down portion.

4. The venetian blind as claimed in claim 2, wherein said outer entrance open end diverges outwardly from said necked down portion.

5. The venetian blind as claimed in claim 1, wherein said clamp element and said insert element are provided with a plurality of surface protrusions.

6. The venetian blind as claimed in claim 5, wherein said surface protrusions on said clamp element are staggered relative to said surface protrusions of said insert element.

7. The venetian blind as claimed in claim 1, wherein said clamp element is formed integrally with said slat.

8. The venetian blind as claimed in claim 1, wherein said clamp element is made of a resilient material.

9. The venetian blind as claimed in claim 1, wherein said insert element is formed integrally with said slat.

10. The venetian blind as claimed in claim 9, wherein said insert element is formed in a substantially ball-shape.
